(19) United States
(12) Patent Application Publication
(10) Pub. No.: US 2026/0343508 A1
(43) Pub. Date: Oct. 29, 2026

(54) TRANSMISSION PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Yi WANG, Dongguan (CN); Gen LI, Dongguan (CN)

(21) Appl. No.: 19/732,624

(22) Filed: Jul. 7, 2026

Related U.S. Application Data
(63) Continuation of application No. PCT/CN2025/070020, filed on Jan. 2, 2025.

(30) Foreign Application Priority Data
Jan. 9, 2024 (CN) 202410031812.6

(51) Int. Cl. H04W 72/0453

(52) U.S. Cl. CPC H04W 72/0453

(57) ABSTRACT

Provided are a transmission processing method and apparatus, a terminal, and a network side device. The transmission processing method includes following operations. A terminal performs a first operation. The first operation includes at least one of the following: determining that a transceiver used in a preset scenario is a default transceiver; and determining, based on target information sent by a network side device, the transceiver used. The preset scenario includes at least one of the following: a preset signal is transmitted; transmission is on a preset resource; and the terminal is in a preset state.

### CROSS-REFERENCE TO RELATED APPLICATIONS

This application is a continuation of International Patent Application No. PCT/CN 2025/070020, filed on Jan. 2, 2025, which claims priority to Chinese Patent Application No. 202410031812.6, filed on Jan. 9, 2024, both of which are incorporated herein by reference in their entireties.

### TECHNICAL FIELD

This application pertains to the field of communication technologies, and specifically relates to a transmission processing method and apparatus, a terminal, and a network side device.

### BACKGROUND

In a communication system, a terminal usually uses a fixed receiver (for example, a primary receiver) to perform data communication. To meet different power consumption requirements and different performance requirements during transmission, it is currently discussed that the terminal may be allowed to support a plurality of transceivers for data communication.

### SUMMARY

Embodiments of this application provide a transmission processing method and apparatus, a terminal, and a network side device.

According to a first aspect, a transmission processing method is provided, including:

A terminal performs a first operation. The first operation includes at least one of the following:
determining that a transceiver used in a preset scenario is a default transceiver; and
determining, based on target information sent by a network side device, the transceiver used.

The preset scenario includes at least one of the following:

A preset signal is transmitted;
transmission is on a preset resource; and
the terminal is in a preset state.

According to a second aspect, a transmission processing method is provided, including:

A network side device sends target information to a terminal. The target information is used to determine a transceiver used by the terminal.

According to a third aspect, a transmission processing apparatus is provided, including:
an execution module, configured to perform a first operation. The first operation includes at least one of the following:
determining that a transceiver used in a preset scenario is a default transceiver; and
determining, based on target information sent by a network side device, the transceiver used.

The preset scenario includes at least one of the following:

A preset signal is transmitted;
transmission is on a preset resource; and
the terminal is in a preset state.

According to a fourth aspect, a transmission processing apparatus is provided, including:
a second sending module, configured to send target information to a terminal. The target information is used to determine a transceiver used by the terminal.

According to a fifth aspect, a terminal is provided. The terminal includes a processor and a memory. The memory stores a program or instructions executable on the processor. When the program or the instructions are executed by the processor, steps of the method according to the first aspect are implemented.

According to a sixth aspect, a terminal is provided, including a processor and a communication interface. The processor is configured to perform a first operation. The first operation includes at least one of the following:
determining that a transceiver used in a preset scenario is a default transceiver; and
determining, based on target information sent by a network side device, the transceiver used.

The preset scenario includes at least one of the following:

A preset signal is transmitted;
transmission is on a preset resource; and
the terminal is in a preset state.

According to a seventh aspect, a network side device is provided. The network side device includes a processor and a memory, and the memory stores a program or an instruction executable on the processor, where the program or the instruction is executed by the processor to implement the steps of the method according to the second aspect.

According to an eighth aspect, a network side device is provided, including a processor and a communication interface. The communication interface is used to send target information to a terminal. The target information is used to determine a transceiver used by the terminal.

According to a ninth aspect, a readable storage medium is provided. The readable storage medium stores a program or instructions. When the program or the instructions are executed by the processor, steps of the method according to the first aspect are implemented, or steps of the method according to the second aspect are implemented.

According to a tenth aspect, a wireless communication system is provided, including: a terminal and a network side device. The terminal may be configured to perform steps of the method according to the first aspect, and the network side device may be configured to perform steps of the method according to the second aspect.

According to an eleventh aspect, a chip is provided. The chip includes a processor and a communication interface. The communication interface is coupled to the processor, and the processor is configured to run a program or instructions to implement the method according to the first aspect or the method according to the second aspect.

According to a twelfth aspect, a computer program/program product is provided. The computer program/program product is stored in a storage medium, and when the computer program/program product is executed by at least one processor to implement steps of the method according to the first aspect, or implement steps of the method according to the second aspect.

### BRIEF DESCRIPTION OF DRAWINGS

FIG. 1 is a block diagram of a wireless communication system to which an embodiment of this application may be applied;

FIG. 2 is a schematic flowchart of a transmission processing method according to an embodiment of this application;

FIG. 3 is a schematic flowchart of another transmission processing method according to an embodiment of this application;

FIG. 4 is a diagram of a structure of a transmission processing apparatus according to an embodiment of this application;

FIG. 5 is a diagram of a structure of another transmission processing apparatus according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DESCRIPTION OF EMBODIMENTS

Terms “first” and “second” in this application are used to distinguish between similar objects, and do not need to be used to describe a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application indicates at least one of connected objects. For example, “A or B” covers three scenarios, that is, a scenario 1: including A but not B; a scenario 2: including B but not A; and a scenario 3: including both A and B. The character “/”usually indicates that associated objects are in an “OR” relationship.

A term “indication” of this application may be either a direct indication (or an explicit indication) or an indirect indication (or an implicit indication). The direct indication may be understood as that, in a sent indication, a sender explicitly notifies a receiver of content such as specific information, an operation that needs to be performed, or a request result. The indirect indication may be understood as that the receiver determines corresponding information based on the indication sent by the sender, or determines, based on a determining result, an operation that needs to be performed, a request result, or the like.

It should be noted that technologies described in embodiments of this application are not limited to a Long Term Evolution (Long Term Evolution, LTE)/LTE-Advanced (LTE-Advanced, LTE-A) system, and may be further applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), or other systems. The terms “system” and “network” in embodiments of this application may be used interchangeably. The technologies described can be applied to both the systems and the radio technologies mentioned above as well as to other systems and radio technologies. A new radio (New Radio, NR) system is described in the following descriptions for illustrative purposes, and the NR terminology is used in most of the following descriptions, although these technologies may also be applied to systems other than the NR system, such as a 6^{th} generation (6^{th} Generation, 6G) communication system.

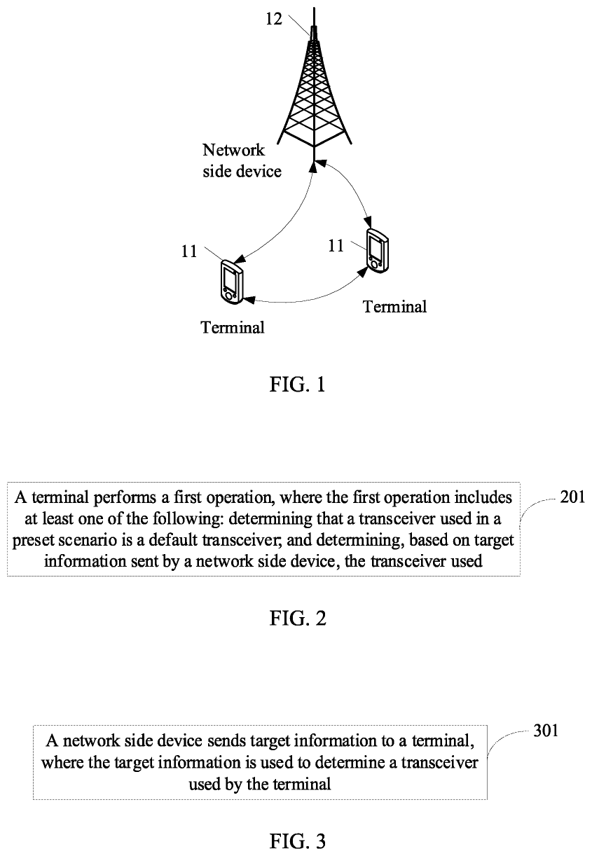

FIG. 1 is a block diagram of a wireless communication system to which an embodiment of this application may be applied. The wireless communication system includes a terminal 11 and a network side device 12. The terminal 11 may be a terminal-side device such as a mobile phone, a tablet computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), a vehicle-mounted device (Vehicle User Equipment, VUE), a ship-mounted device, pedestrian terminal (Pedestrian User Equipment, PUE), a smart household (a household device having a wireless communication function, such as a refrigerator, a television, a washing machine, or furniture), a game console, a personal computer (Personal Computer, PC), a teller machine, or a self-service machine. The wearable device includes a smart watch, a smart band, a smart headset, smart glasses, smart jewelry (a smart bracelet, a smart hand chain, a smart ring, a smart necklace, a smart anklet, a smart ankle chain), a smart wristband, smart clothing, and the like. The vehicle-mounted device may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a NodeB (NodeB, NB), an evolved NodeB (Evolved NodeB, eNB), a next generation NodeB (next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), transmission reception point (Transmission Reception Point, TRP), or another appropriate term in the field, as long as same technical effect is achieved. The base station is not limited to a specific technical term. It should be noted that, in embodiments of this application, only a base station in an NR system is used as an example for description, and a specific type of the base station is not limited.

For ease of understanding, some content related to embodiments of this application is described below.

1. Low power wake-up signal (Low power wake-up signal, LP-WUS), low power synchronization signal (Low power synchronization signal, LP-SS), and low power wake-up receiver (Low power wake-up receiver, LP WUR).

3GPP has introduced the LP WUR and WUS into mobile cellular systems. The basic working principle of the LP WUR is that a receive end includes a first module and a second module. The first module is a main communication module, configured to receive communication data transmitted by a transmit end and send communication data. The second module is a low-power module, configured to receive the LP-WUS and the LP-SS that are sent by the transmit end. The low power wake-up signal is used to wake up the main communication module of the receive end. The low power synchronization signal is used to provide time reference information and other information for receiving the low power wake-up signal, for example, used to perform RRM measurement on a serving cell, and may also provide wake-up link management. When the first module is not woken up by the second module, the first module is always in a disabled state, and does not send or receive data. When downlink data arrives, the second module detects a wake-up signal sent by the transmit end, and the wake-up signal includes information about the terminal, the second module triggers the first module to switch from the disabled state to a working state to receive and send data. The second module may be continuously enabled or discontinuously enabled. When the second module is enabled, the second module may receive the low power wake-up signal and the low power synchronization signal. The LP WUR cannot send and receive communication data, and the LP WUR can only receive a signal transmitted at a low rate.

2. Performance requirements of the terminal

In an NR or LTE system, there are a plurality of terminal types, for example, common user equipment (User Equipment, UE), a reduced capability (Reduced Capability, Redcap) terminal, and a narrowband internet of things (Narrowband Internet of Things, NB-IoT) terminal. Generally, the 3rd generation partner project (3rd Generation Partnership Project, 3GPP) separately defines requirements (requirement) for different terminal types. Some performance requirements are the same for all terminals. For example, for all types of UEs, a carrier frequency offset does not exceed ±0.1 ppm. Some performance requirements vary across different terminals, such as an auxiliary communications service (Auxiliary Communications Service, ACS).

Various types of terminals need to meet their own performance requirements.

Currently, for a type of a device such as Redcap and NB-IoT, an operating bandwidth is reduced, receiving/sending branches are reduced (for example, there is only one receive antenna), a peak rate is limited, and the like. Power consumption and costs of the type of device are reduced compared with common NR or LTE UE. However, a transmission rate of this type of terminal device is limited, and a requirement that a same device may support high-rate transmission, and may also support medium-rate transmission with reduced power cannot be met. For example, a same terminal supports different service types. At a moment t0, reduced power consumption may be used to support a service 1 transmitted at a medium rate. At a moment t1, high power may be used to support a service 2 at a higher transmission rate. To meet the requirements of a terminal supporting different transmission rates and power consumption, the terminal may use a plurality of transceivers. Performance of different transceivers may be different. For example, a carrier frequency offset of a low power transceiver may be relaxed from 0.1 ppm accuracy of an NR or LTE terminal to 10 or 20 ppm, or transmission modulation quality of a transceiver may be degraded. For example, an error vector magnitude (Error Vector Magnitude, EVM), carrier leakage, or in-band leakage (In band leakage, IBE) increases. The terminal needs to determine which transceiver is used for data transmission at a current moment. Therefore, the transmission processing method of this application is proposed.

With reference to the accompanying drawings, a transmission processing method provided in the embodiments of this application is described in detail by using some embodiments and application scenarios.

With reference to FIG. 2, an embodiment of this application provides a transmission processing method. As shown in FIG. 2, the transmission processing method includes the following steps.

Step 201: A terminal performs a first operation. The first operation includes at least one of the following:
determining that a transceiver used in a preset scenario is a default transceiver; and
determining, based on target information sent by a network side device, the transceiver used.

The preset scenario includes at least one of the following:

A preset signal is transmitted;
transmission is on a preset resource; and
the terminal is in a preset state.

In this embodiment of this application, transmission includes at least one of sending and receiving. For example, transmission of the preset signal includes receiving of the preset signal and sending of the preset signal. Receiving of the preset signal includes measurement based on the preset signal or detection of the preset signal.

Optionally, the preset signal may include at least one of the following: a synchronization signal block (Synchronization Signal and PBCH block, SSB), system information, a message 1 (Msg1), Msg2, Msg3, Msg4, MsgA, and MsgB. The system information may include scheduling information, such as a system information block (System Information Block, SIB) 1 or remaining minimum system information (Remaining Minimum SI, RMSI).

Optionally, the preset resource may be understood as a preset frequency domain resource. For example, transmission on the preset resource may include: sending, receiving, or measurement on an initial bandwidth part (initial Bandwidth Part, initial BWP) or a BWP including the initial BWP.

Optionally, the preset state may be a non-connected state. For example, the terminal being in the preset state may be understood as or replaced with the terminal performing transmission in the preset state, for example, the terminal performing sending and receiving in an idle (idle) state or in an inactive (inactive) state.

Optionally, the determining, based on target information sent by a network side device, the transceiver used may be understood as follows: determining, based on the target information sent by the network side device, an available transceiver or a to-be-activated transceiver. In this way, the network side device may flexibly indicate, based on a type of a service that needs to be transmitted, the transceiver used by the terminal to perform data communication, thereby implementing an effect of flexibly controlling power consumption based on a service requirement.

In this embodiment of this application, a first operation is executed by using a terminal. The first operation includes at least one of the following: determining that a transceiver used in a preset scenario is a default transceiver; and determining, based on target information sent by a network side device, the transceiver used. The preset scenario includes at least one of the following: A preset signal is transmitted; transmission is on a preset resource; and the terminal is in a preset state. In this way, because a manner of determining a transceiver is specified, the terminal can support a plurality of transceivers for data communication. Therefore, in this embodiment of this application, flexibility of using the transceiver is improved, so that power consumption can be flexibly controlled based on a service requirement.

Optionally, in some embodiments, the target information includes at any one of the following:
configuration information of a frequency domain resource unit;
configuration information of a first signal; and
transmission mode-related information.

In this embodiment of this application, a granularity of the frequency domain resource unit may be set based on an actual requirement. For example, in some embodiments, the frequency domain resource unit includes a carrier or a bandwidth part BWP. The configuration information of the frequency domain resource unit includes information used to determine a location and a size of a frequency domain resource, and also includes other information used to determine a reference signal or a physical channel transmitted on the frequency domain resource.

Optionally, the first signal may be understood as a reference signal or a physical channel.

It should be understood that, because at least one of the configuration information of the frequency domain resource unit, the configuration information of the first signal, and the transmission mode-related information is used to indicate the transceiver used by the terminal, additional signaling does not need to be added to separately indicate the transceiver. This simplifies a communication process and reduces resource overheads.

Optionally, in some embodiments, when the target information includes the configuration information of the frequency domain resource unit, the determining, based on target information sent by a network side device, the transceiver used includes:
determining, based on the configuration information of the frequency domain resource unit sent by the network side device, a transceiver used for transmitting a signal on the frequency domain resource unit.

In this embodiment of this application, the signal may be understood as a reference signal or a physical channel.

Optionally, one frequency domain resource unit may have one or more available transceivers, that is, one frequency domain resource unit is associated with at least one available transceiver.

Optionally, in some embodiments, when one frequency domain resource unit is associated with one available transceiver, the method further includes:
performing a second operation in the preset scenario and when a first target object does not support the default transceiver.

The first target object is a currently activated frequency domain resource unit, and the second operation includes any one of the following:
keeping the first target object in an active state, stopping transmission behavior on the first target object, and transmitting the preset signal via the default transceiver; and
deactivating the first target object, activating a second target object, and transmitting the preset signal on the second target object via the default transceiver, where the second target object is the frequency domain resource unit that supports the default transceiver.

In this embodiment of this application, switching between different transceivers may be performed through switching of the frequency domain resource unit. The switching of the frequency domain resource unit may be performed based on an indication of the network side device or based on a predefined rule.

Optionally, when the second target object is activated, after completing transmission of the preset signal, the terminal may remain on the second target object, or deactivate a second resource object based on the predefined rule, and activate a first resource object.

It should be noted that, in this embodiment of this application, when a transceiver used for the frequency domain resource unit is configured or indicated by using the configuration information of the frequency domain resource unit, a transceiver type used for the frequency domain resource unit may be explicitly configured or indicated in the configuration information of the frequency domain resource unit. Different transceivers or different transceiver types correspond to different transceiver indicator requirements. In some embodiments, the transceiver used for the frequency domain resource unit may alternatively be implicitly configured or indicated based on other configuration information in the configuration information of the frequency domain resource unit. For example, in some embodiments, the determining, based on the configuration information of the frequency domain resource unit sent by the network side device, a transceiver used for transmitting a signal on the frequency domain resource unit includes any one of the following:
determining, based on first configuration information of the frequency domain resource unit sent by the network side device, the transceiver used for transmitting the signal on the frequency domain resource unit, where the first configuration information is used to configure a transceiver type used by the frequency domain resource unit; and
determining, based on the second configuration information of the frequency domain resource unit sent by the network side device, the transceiver used for transmitting the signal on the frequency domain resource unit, where the second configuration information includes at least one of the following: a subcarrier spacing (Subcarrier Spacing, SCS), a cyclic prefix (cyclic prefix, CP), a modulation and coding scheme (Modulation and coding scheme, MCS) table, a maximum number of receive antennas, a maximum number of transmit antennas, a maximum number of layers, a maximum rank (rank), a fast Fourier transform (Fast Fourier Transform, FFT) length, an inverse fast Fourier transform (Inverse Fast Fourier Transform, IFFT) length, a waveform, and a channel structure.

In this embodiment of this application, the configuration information of the frequency domain resource unit may include the second configuration information or include the first configuration information and the second configuration information. The first configuration information may be understood as configuration information used to explicitly configure or indicate the transceiver type. The second configuration information may be understood as the other configuration information of the frequency domain resource unit, which is used to implicitly configure or indicate the transceiver type.

Optionally, in some embodiments, when one frequency domain resource unit is associated with at least two available transceivers, the method further includes at least one of the following:
determining, by the terminal based on indication information sent by the network side device, a transceiver used within a preset time period; and
activating or deactivating, by the terminal based on a first timer, a transceiver associated with the first target object, where the first target object is a currently activated frequency domain resource unit.

In this embodiment of this application, when one frequency domain resource unit is associated with at least two available transceivers, a transceiver used for transmission may be switched on one frequency domain resource unit. In some embodiments, the transceiver used for current transmission may be switched by using indication information, or the transceiver used for current transmission may be switched by using a timer.

Optionally, the preset time unit may be understood as a period of time or a specific time unit. In this case, the indication information sent by the network side device may be semi-persistent configuration information or indication information of a media access control-control element (Media Access Control-Control Element, MAC CE) or L1 signaling. The indication information is used to determine a transceiver used within the preset time period.

Optionally, the first timer may reuse a currently defined timer, or may use a newly defined dedicated timer.

Optionally, in some embodiments, the activating or deactivating, by the terminal based on a first timer, a transceiver associated with the first target object includes:
when the currently activated transceiver is a first transceiver, deactivating the first transceiver and activating the second transceiver based on the first timer, where the transceiver associated with the first target object includes the first transceiver and the second transceiver, and the second transceiver is a default transceiver of the first target object.

Optionally, in some embodiments, when the currently activated transceiver is the second transceiver, based on a second timer, a third target object is deactivated and a default frequency domain resource unit is activated.

The second transceiver is a default transceiver of the third target object, the third target object is the currently activated frequency domain resource unit, and the third target object is a non-default frequency domain resource unit.

Optionally, that based on a second timer, a third target object is deactivated and a default frequency domain resource unit is activated may be understood as that the second timer may be used as a condition for deactivating the third target object and activating the default frequency domain resource unit. For example, in some embodiments, when the second timer expires, if another condition for deactivating the third target object is satisfied, the third target object is deactivated. For another example, when the second timer expires, if another condition for deactivating the third target object is not satisfied, the third target object is deactivated after the another condition is satisfied.

Optionally, the second timer may be a BWP inactivity timer (bwp-InactivityTimer).

Optionally, if the terminal supports a plurality of activated BWPs at a moment, the plurality of BWPs are in an active state, and the plurality of BWPs in the active state correspond to different transceivers, the terminal may use only one transceiver for transmission. For example, the terminal selects a transceiver for transmission based on at least one of a configuration, scheduling, and the predefined rule of the network side device. Alternatively, the terminal may use different transceivers for transmission at the same time.

Optionally, in some embodiments, when the target information includes the configuration information of the first signal, the determining, based on target information sent by a network side device, the transceiver used includes at least one of the following:
determining, based on the configuration information of the first signal sent by the network side device, a transceiver used for the first signal; and
determining, based on the configuration information of the first signal sent by the network side device, a transceiver used for a second signal, where the second signal is associated with the first signal.

In this embodiment of this application, when a transceiver used by the first signal is configured or indicated by using the configuration information of the first signal, a transceiver type used by the first signal may be explicitly configured or indicated in the configuration information of the first signal. Different transceivers or different transceiver types correspond to different transceiver indicator requirements. In some embodiments, the transceiver used by the first signal may alternatively be implicitly configured or indicated based on other configuration information in the configuration information of the first signal. For example, in some embodiments, the determining, based on the configuration information of the first signal sent by the network side device, a transceiver used by the first signal includes any one of the following:
determining, based on third configuration information of the first signal sent by the network side device, the transceiver used for the first signal, where the third configuration information is used to configure a transceiver type used by the first signal; and
determining, based on fourth configuration information of the first signal sent by the network side device, the transceiver used for the first signal, where the fourth configuration information includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, and a signal type.

In this embodiment of this application, the configuration information of the first signal may include the fourth configuration information or include the third configuration information and the fourth configuration information. The third configuration information may be understood as configuration information used to explicitly configure or indicate the transceiver type. The fourth configuration information may be understood as the other configuration information of the first signal, which is used to implicitly configure or indicate the transceiver type.

Optionally, in some embodiments, the determining, based on the configuration information of the first signal sent by the network side device, a transceiver used for the first signal includes:
determining, based on the configuration information of the first signal sent by the network side device, transceivers used for different configuration information of the first signal.

In this embodiment of this application, for a specific signal, there may be a plurality of sets of configuration information, that is, the transceiver type may be determined for each configuration. For example, semi-persistent scheduling (Semi-Persistent Scheduling, SPS) physical downlink shared channel (Physical downlink shared channel, PDSCH) has a plurality of sets of configuration information. 1^{st} configuration information uses a first transceiver, and 2^{nd} configuration information uses a second transceiver. For example, a plurality of search spaces may be configured for a physical downlink control channel (Physical downlink control channel, PDCCH). A first search space uses the first transceiver, and a second search space uses the second transceiver. For example, for signals of different priorities, different transceivers may be configured for each priority (a low priority or a high priority).

Optionally, the determining, based on the configuration information of the first signal sent by the network side device, a transceiver used for a second signal may be understood as that the transceiver of the first signal may be determined based on the transceiver of the associated second signal. For example, a transceiver type of a PDSCH or a physical uplink shared channel (Physical uplink shared channel, PUSCH) is the same as a transceiver type of a PDCCH that schedules the PDSCH or the PUSCH. For another example, a transceiver type of a physical uplink control channel (Physical uplink control channel, PUCCH) is the same as a transceiver type of a PDSCH that corresponds to a hybrid automatic repeat request response (Hybrid automatic repeat request acknowledgment, HARQ-ACK) carried on the PUCCH.

Optionally, in some embodiments, when the target information includes the transmission mode-related information, the determining, based on target information sent by a network side device, the transceiver used includes:
determining a transceiver for a target transmission mode based on the transmission mode-related information, sent by the network side device, of the target transmission mode, where
the transmission mode-related information includes a transmission mode parameter or target indication information, and the target indication information is used to semi-persistently or dynamically indicate the target transmission mode.

Optionally, in some embodiments, the transmission mode parameter includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, and a transceiver type.

In this embodiment of this application, the network side device may semi-persistently or dynamically indicate the transmission mode-related information. For example, in some embodiments, the transmission mode-related information may be carried in the configuration information of the frequency domain resource unit. Optionally, one frequency domain resource unit can be configured with only one transmission mode, or one frequency domain resource unit can be configured with only a plurality of transmission modes. The network side device further indicates a currently used transmission mode via downlink control information (Downlink Control Information, DCI) or the MAC CE.

Optionally, in some embodiments, the transmission mode-related information may be indicated via radio resource control (Radio Resource Control, RRC) or the MAC CE.

Optionally, in some embodiments, the transmission mode-related information may be carried in DCI for scheduling the PDSCH or the PUSCH.

Optionally, in some embodiments, the transmission mode-related information may be carried in the configuration information of the first signal, for example, carried in configuration information of configuring the SPS PDSCH or a CG PUSCH, carried in configuration information of configuring a periodic PUCCH, carried in information of configuring a PUCCH resource, carried in configuration information of configuring a CSI-RS and a SRS, carried in configuration information of configuring the PDCCH (for example, carried in configuration information of the search space, or carried in configuration information of a CORESET), carried in configuration information of configuring a PRACH, or carried in configuration information of configuring an SSB.

Optionally, in some embodiments, the target information carries time indication information, and the time indication information is used to indicate effective time.

For example, the transmission mode-related information may include the time indication information. In this case, the transmission mode-related information may be a time unit-transmission mode pattern (which is used to indicate an association relationship between the time unit and the transmission mode). Transmission modes of time units may be the same or different. In this case, the transmission mode-related information is equivalent to a time unit-transceiver type pattern configured for the network side device (which is used to indicate an association relationship between the time unit and a transceiver type pattern). Transceivers or transceiver types of the time units may be the same or different.

Optionally, in some embodiments, effective time of the target transceiver is determined based on at least one of the following:
time indication information carried in the target information;
a time unit in which downlink control information that carries the target information is located; and
a time unit in which a signal scheduled or configured by downlink control information that carries the target information is located.

The target transceiver is the transceiver determined for use based on the target information.

In this embodiment of this application, that the effective time of the target transceiver is determined based on the time indication information carried in the target information may be understood as that an effective time unit corresponding to the transceiver is determined based on the time indication information, and may also be understood as that the effective time of the target transceiver includes all time units from start effective time of the time indication information carried in the target information to start effective time of time indication information carried in newly received target information. The start effective time of the time indication information carried in the target information may be understood as or replaced with start effective time of the target information.

Optionally, when the effective time of the target transceiver is determined based on at least two of the foregoing items, it may be understood that the effective time unit of the target transceiver includes a union of effective time units determined based on the at least two items. For example, the effective time unit of the target transceiver may include the time unit in which downlink control information that carries the target information is located, and the time unit in which a signal scheduled or configured by downlink control information that carries the target information is located.

Optionally, in some embodiments, if one time unit corresponds to a plurality of transceivers, a manner of determining the transceiver includes the following manners.

If a same time-frequency resource corresponds to the plurality of transceiver, the terminal determines a transceiver based on the predefined rule.

If the terminal cannot use different transceivers for transmission at the same time, the terminal determines a transceiver based on the predefined rule.

Optionally, in some embodiments, the terminal does not expect to use a plurality of transceivers for transmission at a moment. The network side device may avoid configuring or scheduling signals that use different transceivers to overlap in time based on implementation.

Optionally, in some embodiments, the terminal may select a transceiver for transmission based on configuration, scheduling, or the predefined rule of the network side device. The predefined rule includes at least selecting a transceiver based on a priority of a signal for transmission.

Optionally, a carrier, a BWP, or a transmission manner that corresponds to a low-priority transceiver is deactivated, or enters a dormant state.

Optionally, in some embodiments, the method further includes:

The terminal sends information about a supported transceiver or information about a transceiver recommended for use to the network side device.

The information about the transceiver includes a transceiver type.

In this embodiment of this application, the terminal may report transceiver information before establishing an RRC connection. For example, the terminal may report the information about the supported transceiver via a preamble (Preamble), MsgA, Msg3, or Msg5. The terminal may alternatively report the transceiver information after the RRC connection is established.

Optionally, in some embodiments, the information about the transceiver further includes at least one of the following:
preference information associated with the transceiver type, where the preference information includes at least one of the following: a discontinuous reception DRX parameter, a ranking level, maximum bandwidth, a quantity of multiple-input multiple-output (MIMO) layers, a minimum time offset for cross-slot scheduling, a relaxed radio link monitoring RLM measurement, and a relaxed beam failure detection measurement; and information about whether to deactivate a secondary cell group SCG;
indication information indicating whether simultaneous working of at least two types of transceivers is supported; and
a performance indicator of the supported transceiver.

Optionally, in some embodiments, different types of transceivers correspond to different indicator requirements, and the indicator requirements include at least one of the following:
a time domain synchronization requirement;
a time domain calibration error requirement;
a frequency error requirement;
a modulation quality requirement;
a fast Fourier transform length requirement; and
an inverse fast Fourier transform length requirement.

In this embodiment of this application, transceivers of different types may be understood as or replaced with different transceivers, or transceivers corresponding to different transceiver types.

Optionally, the fast Fourier transform length requirement may be understood as or replaced with an FFT quantity requirement, and the inverse fast Fourier transform length requirement may be understood as or replaced with an IFFT quantity requirement.

It should be noted that the terminal determining the transceiver used is equivalent to determining an indicator requirement corresponding to receiving and sending.

It should be understood that, when the terminal does not receive the target information, the terminal may use the default transceiver.

For better understanding of this application, the following uses some examples for description.

Embodiment 1: The terminal may support a plurality of transceivers, and the terminal may use different transceivers in different scenarios. Based on an implementation, in some specific scenarios (or referred to as preset scenarios), the terminal uses the default transceiver for transmission. The specific scenario includes at least one of the following:

The terminal uses the default transceiver to receive the preset signal, where the preset signal includes at least one of the following: an SSB (for example, a non-cell-defined SSB (NCD-SSB) or an SSB used for initial access), system information (including scheduling information), a downlink signal in a random access process (for example, Msg2, Msg4, or MsgB in a contention-based random access procedure), and a downlink signal (for example, a paging PDCCH or PDSCH) in a paging (paging) process;
the terminal uses the default transceiver to measure the preset signal, for example, SSB-based radio resource management (RRM) measurement or radio link management (RLM) measurement, for example, SSB-based synchronization;
the terminal uses the default transceiver to send the preset signal, for example, an uplink signal (sending of Msg1, Msg3, or MsgA) in the random access process;
the terminal uses the default transceiver for transmission on a specific frequency domain resource, for example, the UE uses the default transceiver for transmission, receiving, or measurement on an initial BWP or a BWP including the initial BWP;
the terminal uses the default transceiver for transmission in the preset state; and
the terminal does not receive information (such as the target information) for explicitly or implicitly configuring another type of transceiver.

Embodiment 2: Activation or deactivation of the transceiver is determined based on activation or deactivation of the BWP or a BWP group.

If the terminal supports a plurality of transceivers, the network side device may be configured with a carrier or a carrier group, or a transceiver type available to the BWP or the BWP group.

In some examples, only one transceiver type may be configured for one BWP or BWP group. The BWP or the transceiver type available to the BWP group may be explicitly configured (for example, a transceiver type 1 and a transceiver type 2 correspond to different transceiver indicator requirements), or may be determined by the terminal based on second configuration information of the BWP.

In some examples, if the terminal supports only one activated BWP or BWP group, the terminal may determine, based on the activated BWP or BWP group, a transceiver that needs to be used for current transmission. For example, the first transceiver is configured for a first BWP, and the second transceiver is configured for a second BWP. If the first BWP is activated, the first transceiver is activated. Alternatively, if the second BWP is activated, the second transceiver is activated. If the first BWP is deactivated, the first transceiver is deactivated. Alternatively, if the second BWP is deactivated, the second transceiver is deactivated.

Optionally, the activated BWP or BWP group may be determined based on BWP indication information sent by the network side device (for example, an ID of the activated BWP, which is indicated in RRC, the MAC CE, or the DCI).

Optionally, the activated or deactivated BWP or BWP group may be determined based on a timer configured by the network side device. If a timer 1 of the first BWP expires, the first BWP is deactivated, and the second BWP is activated. Both the first BWP and the second BWP are BWPs corresponding to a same transceiver. For example, the terminal supports two transceivers. The base station may configure two default BWPs for a serving cell of the terminal, which respectively correspond to two transceivers. If bwp-InactivityTimer of the first BWP of a same transceiver expires, the first BWP is deactivated, and the second BWP (the default BWP of the transceiver) is activated. Optionally, if the currently activated BWP is a default BWP of the first transceiver, the BWP of the first transceiver may be deactivated based on a timer 2, and the BWP of the second transceiver may be activated. For example, the BWP of the second transceiver is a default BWP of the second transceiver. Optionally, the timer 2 and the timer 1 may be separately configured.

Alternatively, if the timer 1 of the first BWP expires, the first BWP is deactivated, and the second BWP is activated. The first BWP and the second BWP may be BWPs corresponding to different transceivers. For example, the base station is configured with only one default BWP for a serving cell of the terminal, and the default BWP corresponds to the second transceiver. If bwp-InactivityTimer of one BWP of the first transceiver expires, the first BWP is deactivated, and the default BWP (the second transceiver) is activated. Optionally, the second BWP (default BWP) corresponds to a specific type of transceiver. For example, the base station can configure only a transceiver corresponding to the default BWP as the second transceiver.

Optionally, a plurality of timers 1, for example, bwp-InactivityTimer, may be configured for a same serving cell. Each timer 1 corresponds to one transceiver. That is, bwp-InactivityTimer of BWPs of a same transceiver is the same, and bwp-InactivityTimer of BWPs of different transceivers may be the same or different. In this way, BWP deactivation of different transceivers can be separately controlled to achieve different energy saving effects for different transceivers.

Optionally, if some specific signals can be transmitted only via a specific transceiver (for example, the default transceiver used in the preset scenario in Embodiment 1), the terminal needs to use the specific transceiver for transmission in a time unit in which the specific signals are present. For example, if the SSB can be received only via the second transceiver, and the currently activated first BWP is the BWP of the first transceiver, some methods need to be used, so that the terminal can use the second transceiver. The following uses different examples for description.

In an example, the first BWP still remains in the active state, but the terminal stops transmitting on the first BWP, and the terminal transmits the preset signal via the specific transceiver. After completing transmission of the preset signal, the terminal continues transmission on the first BWP. For example, the terminal stops transmission on the first BWP before a window for measuring the SSB starts (a gap may be reserved switching time), and receives the SSB via the second transceiver. The terminal resumes transmission on the first BWP after the window for measuring the SSB ends (a gap may be reserved as switching time). If no receiving or sending is performed on the first BWP because the terminal switches transceivers, the BWP is deactivated. To avoid this, the inactivity timer of the BWP stops timing in a time period in which the terminal uses the second transceiver to transmit the preset signal and switching time in which the terminal switches the transceiver.

In an example, the first BWP is automatically deactivated, and the second BWP on which the preset signal is located is automatically activated. The terminal transmits the preset signal on the second BWP via the second transceiver. After completing transmission of the preset signal, the terminal remains on the second BWP, or after completing transmission of the preset signal, the terminal deactivates the second BWP and activates the first BWP based on the predefined rule.

In an example, the first BWP still remains in the active state, the terminal may perform transmission on the first BWP, and the terminal also transmits the preset signal via the specific transceiver. For example, the terminal may receive the SSB on the first BWP via both the first transceiver and the second transceiver. This manner is applicable to a terminal that supports simultaneous working of a plurality of transceivers.

It should be understood that the foregoing BWP deactivation manner is also applicable to a case in which there are a plurality of carriers and the terminal cannot simultaneously use different transceivers for transmission.

In some embodiments, if the terminal supports a plurality of activated BWPs or BWP groups, the terminal may determine, in at least one of the following manners, a transceiver that needs to be used for current transmission.

In an example, if the plurality of BWPs are in the active state, and the plurality of BWPs in the active state correspond to different transceivers, the terminal performs transmission only on a part of BWPs, and the part of BWPs correspond to one transceiver. For example, the terminal does not expect to use a plurality of transceivers for transmission at the same time. The network side device ensures, based on implementation, that only one transceiver is used for transmission in a time unit. Alternatively, the terminal determines, based on the configuration, scheduling, or the predefined rule of the network side device, a transceiver for transmission. The predefined rule includes at least selecting a transceiver based on a priority of a signal for transmission. For example, a priority of a scheduling-based signal is higher than that of a semi-persistent signal (except for a specific semi-persistent signal, for example, an SSB). An activated BWP corresponding to a transceiver that is not used may automatically enter the dormant state. Alternatively, the network side device may configure an activated BWP of a transceiver as a dormant BWP (Dormant BWP).

Optionally, in the dormant BWP, the terminal stops any transmitting/receiving behavior.

Optionally, the dormant BWP is supported only in a SCell, or the dormant BWP may also be supported in a PCell. However, only a dormant BWP existing is not supported in the PCell. For example, a BWP of at least one transceiver in the PCell cannot enter the dormant state.

In an example, if the plurality of BWPs are in the active state, and the plurality of BWPs in the active state correspond to different transceivers, the terminal may perform transmission on the plurality of BWPs. Optionally, the terminal may perform transmission on the plurality of BWPs only in a specific condition. For example, to support transmission of the preset signal, for example, transmission of an SSB, the terminal may perform transmission on the activated first BWP (the first transceiver), and also receive the SSB on the second BWP (the second transceiver). In addition to transmission of the preset signal, the terminal performs transmission only on a part of BWPs, and the part of BWPs correspond to a transceiver.

In some embodiments, one BWP or BWP group may support a plurality of transceiver types. For example, a network node configures two transceiver types for one BWP. In the BWP, switching between different transceivers may be performed, and a transceiver for current transmission is determined in at least one of the following manners.

In an example, a transceiver type for a specific time period or a specific time unit is determined based on indication information. The indication information is semi-persistent configuration information, or indication information of the MAC CE or L1 signaling.

For example, the indication information is a time unit-transceiver pattern. Configured transceivers of time units may be different or the same. For another example, the indication information is signaling for activating or deactivating a transceiver.

In an example, a timer-based transceiver is activated or deactivated.

It is assumed that the default transceiver is the first transceiver. If the second transceiver is currently activated, the second transceiver may be deactivated based on the first timer, and the first transceiver is activated. If the second transceiver is currently activated, the BWP may be deactivated based on the second timer. Optionally, the second timer is bwp-InactivityTimer of the BWP. If the second timer expires, the BWP is deactivated, and the default BWP is activated.

The first timer is a transceiver activation or deactivation timer, and the second timer is a BWP activation or deactivation timer.

In some embodiments, a signal is configured to determine a transceiver used for the signal. The transceiver type used by the signal may be explicitly configured, or may be determined based on other configuration information of the signal.

Optionally, the explicitly configured transceiver type includes at least one of the following:
a transceiver type, indicated by the DCI for scheduling the PDSCH, the PUSCH, the PUCCH, the SRS, and the CSI-RS, used by the scheduled PDSCH, PUSCH, PUCCH, SRS, and CSI-RS;
a transceiver type configured in configuration information of configuring a semi-persistent signal, for example, carried in configuration information of configuring the SPS PDSCH or a CG PUSCH, carried in configuration information of configuring a periodic PUCCH, carried in information of configuring a PUCCH resource, carried in configuration information of configuring a CSI-RS and a SRS, carried in configuration information of configuring the PDCCH (for example, carried in configuration information of the search space SS, or carried in configuration information of a CORESET), carried in configuration information of configuring a PRACH, or carried in configuration information of configuring an SSB; and
a transceiver type determined based on the second configuration information of the signal.

Optionally, if a specific signal has a plurality of pieces of configuration information, the transceiver type may be determined for per piece of configuration information.

For example, the SPS PDSCH has a plurality of pieces of configuration information (which may be understood as a plurality of groups of SPS PDSCHs). 1^{st} configuration information uses the first transceiver (that is, a first group of SPS PDSCHs uses the first transceiver), and 2^{nd} configuration information uses the second transceiver (that is, the second group of SPS PDSCHs uses the second transceiver). For example, a plurality of search spaces may be configured for the PDCCH (for example, different configuration information is associated with different search spaces). A first search space uses the first transceiver, and a second search space uses the second transceiver. For example, for signals of different priorities (for example, different configuration information is associated with different priorities), different transceivers may be configured for each priority (a low priority or a high priority).

Optionally, a transceiver of a specific signal may be determined through a transceiver used by a signal associated with the specific signal. For example, a transceiver type of a PDSCH or PUSCH is the same as a transceiver type of a PDCCH that schedules the PDSCH or PUSCH. For example, a transceiver type of a PUCCH carrying a HARQ-ACK is the same as a transceiver type of a PDSCH that corresponds to the HARQ-ACK.

Embodiment 3: Activation or deactivation of the transceiver is determined based on configuration or indication of the transmission mode.

If the terminal supports a plurality of transceivers, the network side device may configure a plurality of transmission modes. Each transmission mode corresponds to a transceiver. The terminal may determine the transceiver used for current transmission based on the transmission mode.

The network side device may semi-persistently or dynamically indicate the transmission mode, for example, through RRC, the MAC CE, or the L1 signaling. Specifically, the following manners may be used for indication.

Indication information of the transmission mode may be carried in configuration information of the BWP. Optionally, only one transmission mode may be configured for one BWP. Alternatively, one BWP may be configured with a plurality of transmission modes. The network side device may further indicate a currently used transmission mode via the DCI or the MAC CE.

The indication information of the transmission mode may be indicated via RRC, the MAC CE, or DCI without data scheduling. Time units applicable to a transmission mode indicated by the indication information of the transmission mode are all time units from time when the signaling indicating the transmission mode starts to take effect to time when new indication information starts to take effect.

Optionally, the indication information of the transmission mode may be carried in the DCI that schedules the PDSCH or PUSCH, or the indication information of the transmission mode may be carried in configuration information of configuring the semi-persistent signal, for example, carried in configuration information of configuring the SPS PDSCH/CG PUSCH, carried in configuration information of configuring a periodic PUCCH, carried in information of configuring a PUCCH resource, carried in configuration information of configuring a CSI-RS and a SRS, carried in configuration information of configuring the PDCCH (for example, carried in configuration information of the search space, or carried in configuration information of a CORESET), carried in configuration information of configuring a PRACH, or carried in configuration information of configuring an SSB. Optionally, the time unit applicable to the indicated transmission mode is a time unit in which a physical signal scheduled or configured in DCI or configuration information carrying the transmission mode indication is located. A time unit in which the physical signal is located is a time resource occupied by the physical signal, a slot or a slot group in which the physical signal is located, a subframe, a subframe group, or a system frame. For example, a transmission mode indicated in the DCI for scheduling a PUSCH is valid only for a time resource of the scheduled PUSCH.

Optionally, the indication information of the transmission mode may include time indication information, for example, a time unit-transmission mode pattern is configured. Transmission modes of the time units may be different or the same.

Optionally, the transmission mode may be switched based on a timer. For example, a first transmission mode is switched to a second transmission mode based on a timer 3. Alternatively, the second transmission mode is switched to the first transmission mode based on a timer 4. Optionally, a default transmission mode is predefined based on a network configuration or standard.

Optionally, if some specific signals can be transmitted (for example, the preset scenario in Embodiment 1) only via a specific transmission mode (a transceiver type), the terminal needs to use the specific transceiver for transmission in a time unit in which the specific signals are present.

In an example, it is assumed that the specific signal needs to use a transmission mode 2. If the specific signal cannot be transmitted in a current transmission mode 1, the terminal automatically switches to the transmission mode 2 to transmit the specific signal. After completing transmission of the preset signal, the terminal automatically switches back to the transmission mode 1. Alternatively, after completing transmission of the preset signal, the terminal remains in the transmission mode 2.

In an example, if the terminal supports working of a plurality of transceivers, and the specific signal and the transmission mode 1 are on different frequency domain resources, for example, on different BWPs, the terminal may simultaneously use the transmission mode 2 to transmit the specific signal on one BWP and use the transmission mode 1 on another BWP.

In some embodiments, if the plurality of BWPs are in the active state, and the plurality of BWPs in the active state correspond to different transmission modes (correspond to different transceivers), the terminal performs transmission only on a part of BWPs, and the part of BWPs correspond to one transceiver. The network side device ensures, based on implementation, that only one transceiver is used for transmission in a time unit. Alternatively, the terminal determines, based on the configuration, scheduling, or the predefined rule of the network side device, a transceiver for transmission.

Embodiment 4: The terminal reports the transceiver information.

Different terminals support different transceiver types. The terminal needs to report the information about the supported transceiver to help the network side device communicate with the terminal in a proper transmission manner. The terminal may report the information before entering a RRC connected state or after entering the RRC connected state.

Before entering the RRC connected state, the terminal may report a supported transceiver type through the preamble, MsgA, Msg3, or Msg5, or through a UE-specific PUSCH. Optionally, the terminal needs to report only a subset of transceiver types that may be supported. For example, the terminal supports a low power transceiver and a common-power transceiver. The normal-power transceiver is used as a type that needs to be supported and does not need to be reported. The terminal only needs to report whether the low power transceiver is supported. Optionally, the terminal reports whether simultaneous working of a plurality of transceivers is supported and which transceivers can simultaneously work. Optionally, the terminal reports a performance indicator of a supported transceiver, for example, a range of a carrier frequency offset (Carrier Frequency Offset, CFO).

Because power consumption of different transceivers is different, the terminal may report a preference on transceiver (preference on transceiver) to the network side device based on a power status of the terminal, to save power. The reporting may be periodic, triggered by an event, or triggered by the network side device, or a terminal implementation determines when to report. The terminal reports the preference on transceiver, and may report a plurality of transceivers and a preference level or preference sequence of each transceiver. Optionally, the terminal may report a preferred DRX parameter of each transceiver, a preferred maximum bandwidth (for example, a maximum aggregated bandwidth), a quantity of MIMO layers, a minimum time offset for cross-slot scheduling, a relaxed RLM measurement, and a relaxed beam failure detection measurement, and whether to deactivate a secondary cell group (Secondary Cell group, SCG).

With reference to FIG. 3, an embodiment of this application further provides a transmission processing method. As shown in FIG. 3, the transmission processing method includes the following steps.

Step 301: A network side device sends target information to a terminal. The target information is used to determine a transceiver used by the terminal.

Optionally, the target information includes any one of the following: configuration information of a frequency domain resource unit; configuration information of a first signal; and transmission mode-related information.

Optionally, the frequency domain resource unit includes a carrier or a bandwidth part BWP.

Optionally, the transmission mode-related information includes a transmission mode parameter or target indication information.

Optionally, the transmission mode parameter includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, and a transceiver type.

Optionally, the target information carries time indication information, and the time indication information is used to indicate effective time.

Optionally, the method further includes:

The network side device receives information about a supported transceiver or information about a transceiver recommended for use from the terminal.

The information about the transceiver includes a transceiver type.

Optionally, the information about the transceiver further includes at least one of the following:
preference information associated with the transceiver type, where the preference information includes at least one of the following: a discontinuous reception DRX parameter, a ranking level, maximum bandwidth, a quantity of multiple-input multiple-output MIMO layers, a minimum time offset for cross-slot scheduling, a relaxed radio link monitoring RLM measurement, and a relaxed beam failure detection measurement; and information about whether to deactivate a secondary cell group SCG;
indication information indicating whether simultaneous working of at least two types of transceivers is supported; and
a performance indicator of the supported transceiver.

Optionally, different types of transceivers correspond to different indicator requirements, and the indicator requirements include at least one of the following:
a time domain synchronization requirement;
a time domain calibration error requirement;
a frequency error requirement;
a modulation quality requirement;
a fast Fourier transform length requirement; and
an inverse fast Fourier transform length requirement.

The transmission processing method provided in embodiments of this application may be performed by a transmission processing apparatus. In embodiments of this application, an example in which the transmission processing apparatus performs the transmission processing method is used to describe the transmission processing apparatus provided in embodiments of this application.

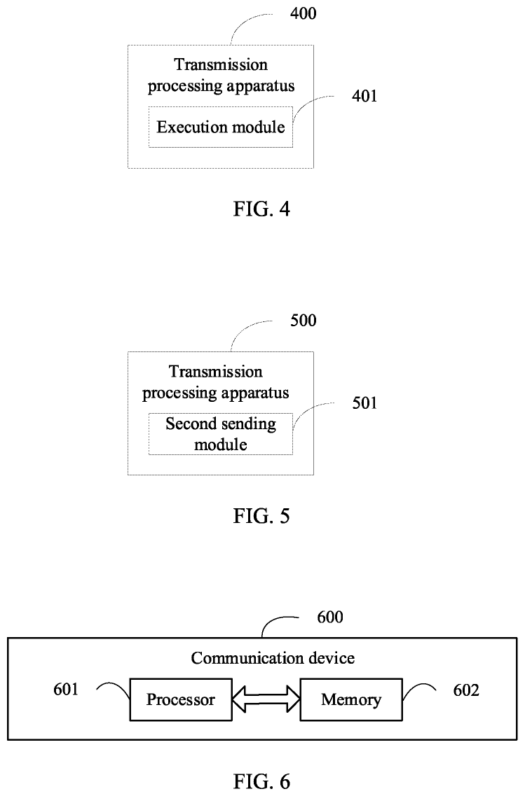

With reference to FIG. 4, an embodiment of this application further provides a transmission processing apparatus. As shown in FIG. 4, the transmission processing apparatus 400 includes:
an execution module 401, configured to perform a first operation. The first operation includes at least one of the following:
determining that a transceiver used in a preset scenario is a default transceiver; and
determining, based on target information sent by a network side device, the transceiver used.

The preset scenario includes at least one of the following:

A preset signal is transmitted;
transmission is on a preset resource; and
the terminal is in a preset state.

Optionally, the target information includes any one of the following:
configuration information of a frequency domain resource unit;
configuration information of a first signal; and
transmission mode-related information.

Optionally, the execution module 401 is specifically configured to: when the target information includes the configuration information of the frequency domain resource unit, determine, based on the configuration information of the frequency domain resource unit sent by the network side device, a transceiver used for transmitting a signal on the frequency domain resource unit.

Optionally, the execution module 401 is specifically configured to perform any one of the following:
determining, based on first configuration information of the frequency domain resource unit sent by the network side device, the transceiver used for transmitting the signal on the frequency domain resource unit, where the first configuration information is used to configure a transceiver type used by the frequency domain resource unit; and
determining, based on the second configuration information of the frequency domain resource unit sent by the network side device, the transceiver used for transmitting the signal on the frequency domain resource unit, where the second configuration information includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, and a channel structure.

Optionally, when one frequency domain resource unit is associated with one available transceiver, the execution module 401 is further configured to perform a second operation in the preset scenario and when a first target object does not support the default transceiver.

The first target object is a currently activated frequency domain resource unit, and the second operation includes any one of the following:
keeping the first target object in an active state, stopping transmission behavior on the first target object, and transmitting the preset signal via the default transceiver; and
deactivating the first target object, activating a second target object, and transmitting the preset signal on the second target object via the default transceiver, where the second target object is the frequency domain resource unit that supports the default transceiver.

Optionally, when one frequency domain resource unit is associated with at least two available transceivers, the execution module 401 is further configured to perform at least one of the following:
determining, based on indication information sent by the network side device, a transceiver used within a preset time period; and
activating or deactivating, based on a first timer, a transceiver associated with the first target object, where the first target object is a currently activated frequency domain resource unit.

Optionally, the execution module 401 is specifically configured to: when the currently activated transceiver is a first transceiver, deactivate the first transceiver and activate the second transceiver based on the first timer. The transceiver associated with the first target object includes the first transceiver and the second transceiver, and the second transceiver is a default transceiver of the first target object.

Optionally, when the currently activated transceiver is the second transceiver, based on a second timer, a third target object is deactivated and a default frequency domain resource unit is activated.

The second transceiver is a default transceiver of the third target object, the third target object is the currently activated frequency domain resource unit, and the third target object is a non-default frequency domain resource unit.

Optionally, the frequency domain resource unit includes a carrier or a bandwidth part BWP.

Optionally, when the target information includes the configuration information of the first signal, the execution module 401 is specifically configured to perform at least one of the following:
determining, based on the configuration information of the first signal sent by the network side device, a transceiver used for the first signal; and
determining, based on the configuration information of the first signal sent by the network side device, a transceiver used for a second signal, where the second signal is associated with the first signal.

Optionally, the execution module 401 is specifically configured to:
determine, based on third configuration information of the first signal sent by the network side device, the transceiver used for the first signal, where the third configuration information is used to configure a transceiver type used by the first signal; and
determine, based on fourth configuration information of the first signal sent by the network side device, the transceiver used for the first signal, where the fourth configuration information includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, and a signal type.

Optionally, the execution module 401 is specifically configured to: determine, based on the configuration information of the first signal sent by the network side device, transceivers used for different configuration information of the first signal.

Optionally, when the target information includes the transmission mode-related information, the execution module 401 is specifically configured to: determine a transceiver for a target transmission mode based on the transmission mode-related information, sent by the network side device, of the target transmission mode.

The transmission mode-related information includes a transmission mode parameter or target indication information, and the target indication information is used to semi-persistently or dynamically indicate the target transmission mode.

Optionally, the transmission mode parameter includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, and a transceiver type.

Optionally, the target information carries time indication information, and the time indication information is used to indicate effective time.

Optionally, effective time of the target transceiver is determined based on at least one of the following:
time indication information carried in the target information;
a time unit in which downlink control information that carries the target information is located; and
a time unit in which a signal scheduled or configured by downlink control information that carries the target information is located.

The target transceiver is the transceiver determined for use based on the target information.

Optionally, the transmission processing apparatus 400 further includes:
a first sending module, configured to send information about a supported transceiver or information about a transceiver recommended for use to the network side device.

The information about the transceiver includes a transceiver type.

Optionally, the information about the transceiver further includes at least one of the following:
preference information associated with the transceiver type, where the preference information includes at least one of the following: a discontinuous reception DRX parameter, a ranking level, maximum bandwidth, a quantity of multiple-input multiple-output MIMO layers, a minimum time offset for cross-slot scheduling, a relaxed radio link monitoring RLM measurement, and a relaxed beam failure detection measurement; and information about whether to deactivate a secondary cell group SCG;
indication information indicating whether simultaneous working of at least two types of transceivers is supported; and
a performance indicator of the supported transceiver.

Optionally, different types of transceivers correspond to different indicator requirements, and the indicator requirements include at least one of the following:
a time domain synchronization requirement;
a time domain calibration error requirement;
a frequency error requirement;
a modulation quality requirement;
a fast Fourier transform length requirement; and
an inverse fast Fourier transform length requirement.

With reference to FIG. 5, an embodiment of this application further provides a transmission processing apparatus. As shown in FIG. 5, the transmission processing apparatus 500 includes:
a second sending module 501, configured to send target information to a terminal. The target information is used to determine a transceiver used by the terminal.

Optionally, the target information includes any one of the following:
configuration information of a frequency domain resource unit;
configuration information of a first signal; and
transmission mode-related information.

Optionally, the frequency domain resource unit includes a carrier or a bandwidth part BWP.

Optionally, the transmission mode-related information includes a transmission mode parameter or target indication information.

Optionally, the transmission mode parameter includes at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, and a transceiver type.

Optionally, the target information carries time indication information, and the time indication information is used to indicate effective time.

Optionally, the transmission processing apparatus 500 further includes:
a receiving module, configured to receive information about a supported transceiver or information about a transceiver recommended for use from the terminal.

The information about the transceiver includes a transceiver type.

Optionally, the information about the transceiver further includes at least one of the following:
preference information associated with the transceiver type, where the preference information includes at least one of the following: a discontinuous reception DRX parameter, a ranking level, maximum bandwidth, a quantity of multiple-input multiple-output MIMO layers, a minimum time offset for cross-slot scheduling, a relaxed radio link monitoring RLM measurement, and a relaxed beam failure detection measurement; and information about whether to deactivate a secondary cell group SCG;
indication information indicating whether simultaneous working of at least two types of transceivers is supported; and
a performance indicator of the supported transceiver.

Optionally, different types of transceivers correspond to different indicator requirements, and the indicator requirements include at least one of the following:
a time domain synchronization requirement;
a time domain calibration error requirement;
a frequency error requirement;
a modulation quality requirement;
a fast Fourier transform length requirement; and
an inverse fast Fourier transform length requirement.

The transmission processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in embodiments of this application.

The transmission processing apparatus provided in the embodiments of this application can implement the processes implemented in the method embodiments in FIG. 2 and FIG. 3, with the same technical effect achieved. To avoid repetition, details are not described herein again.

As shown in FIG. 6, an embodiment of this application further provides a communication device 600, including a processor 601 and a memory 602. The memory 602 stores a program or instructions executable on the processor 601. When the program or the instructions are executed by the processor 601, the steps of the foregoing transmission processing method embodiments are implemented, and same technical effect can be achieved. To avoid repetition, details are not described herein again.

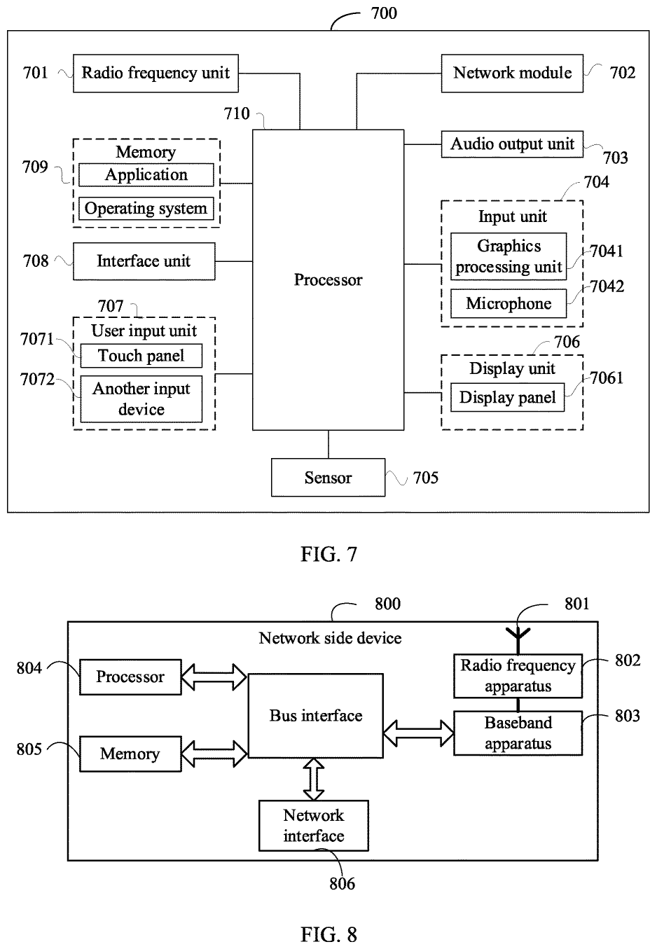

An embodiment of this application further provides a terminal, including a processor and a communication interface. The communication interface is coupled to the processor, and the processor is configured to run a program or instructions to implement the steps in the method embodiment shown in FIG. 2. The terminal embodiment corresponds to the method embodiment on the terminal side, each implementation process and implementation of the method embodiment can be applied to the terminal embodiment, and same technical effect can be achieved. Specifically, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

It may be understood by a person skilled in the art that the terminal 700 may further include a power supply (for example, a battery) that supplies power to each component. The power supply may be logically connected to the processor 710 by using a power management system, so that functions such as charge and discharge management and power consumption management are implemented by using the power management system. The terminal structure shown in FIG. 7 does not constitute a limitation on the terminal, and the terminal may include more or fewer components than shown, or combine some components, or have different component arrangements. This is not described herein again.

It should be understood that in this embodiment of this application, the input unit 704 may include a graphics processing unit (Graphics Processing Unit, GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). The memory 709 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The processor 710 is configured to perform a first operation. The first operation includes at least one of the following:
determining that a transceiver used in a preset scenario is a default transceiver; and
determining, based on target information sent by a network side device, the transceiver used.

The preset scenario includes at least one of the following:

A preset signal is transmitted;
transmission is on a preset resource; and
the terminal is in a preset state.

It may be understood that for an implementation process of each implementation provided in this embodiment, refer to the related descriptions in the method embodiments on a terminal side, and corresponding technical effects can be achieved. To avoid duplication, details are not described herein again.

An embodiment of this application further provides a network side device, including a processor and a communication interface. The communication interface is coupled to the processor, and the processor is configured to run a program or instructions to implement the steps in the method embodiment shown in FIG. 3. This network side device embodiment corresponds to the foregoing method embodiment of the network side device. Each implementation process and implementation of the foregoing method embodiment is applicable to this network side device embodiment, and a same technical effect can be achieved.

Specifically, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

The baseband apparatus 803 may include, for example, at least one baseband board. A plurality of chips are disposed on the baseband board. As shown in FIG. 8, one chip is, for example, a baseband processor, and is connected to the memory 805 through a bus interface, to invoke a program in the memory 805, and perform operations of the network side device shown in the foregoing method embodiments.

The network side device may further include a network interface 806, and the interface is, for example, a common public radio interface (Common Public Radio Interface, CPRI).

Specifically, the network side device 800 in this embodiment of this application further includes instructions or a program, executable on the processor 804, that is stored in the memory 805. The processor 804 invokes the instructions or the program in the memory 805 to perform the method performed by the modules shown in FIG. 5, and same technical effect can be achieved. To avoid repetition, details are not described herein again.

An embodiment of this application further provides a readable storage medium. The readable storage medium stores a program or an instruction. When the program or the instruction is executed by a processor, the processes in the foregoing transmission processing method embodiments are implemented, with the same technical effects achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application still provides a chip. The chip includes a processor and a communication interface, and the communication interface is coupled to the processor. The processor is configured to run a program or an instruction, to implement various processes of the foregoing embodiments of the transmission processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement each process of the foregoing transmission processing method embodiments, and same technical effect can be achieved. To avoid repetition, details are not described herein again.

An embodiment of this application further provides a wireless communication system, including a terminal and a network side device. The terminal may be configured to perform the foregoing steps, on the terminal side, of the transmission processing method, and the network side device may be configured to perform the foregoing steps, on the network side device, of the transmission processing method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

According to the foregoing descriptions of the implementations, a person skilled in the art may clearly understand that the foregoing method embodiments may be implemented by using a computer software product and a required universal hardware platform, or certainly may be implemented by using hardware. The computer software product is stored in a storage medium (such as a ROM, a RAM, a magnetic disk, or an optical disc), and includes several instructions for instructing a terminal or a network side device to perform the methods described in the embodiments of this application.

The foregoing describes embodiments of this application with reference to the accompanying drawings. However, this application is not limited to the foregoing specific implementations. The foregoing specific implementations are merely examples instead of limitations. Inspired by this application, a person of ordinary skill in the art may further make implementations in many forms without departing from the purposes of this application and the protection scope of the claims, and all the implementations shall fall within the protection of this application.

1. A transmission processing method, comprising:
performing, by a terminal, a first operation, wherein the first operation comprises at least one of the following:
determining that a transceiver used in a preset scenario is a default transceiver; or
determining, based on target information sent by a network side device, the transceiver used, wherein
the preset scenario comprises at least one of the following:
a preset signal is transmitted;
transmission is on a preset resource; or
the terminal is in a preset state.

2. The method according to claim 1, wherein the target information comprises any one of the following:
configuration information of a frequency domain resource unit;
configuration information of a first signal; and
transmission mode-related information.

3. The method according to claim 2, wherein when the target information comprises the configuration information of the frequency domain resource unit, the determining, based on target information sent by a network side device, the transceiver used comprises:
determining, based on the configuration information of the frequency domain resource unit sent by the network side device, a transceiver used for transmitting a signal on the frequency domain resource unit.

4. The method according to claim 3, wherein the determining, based on the configuration information of the frequency domain resource unit sent by the network side device, a transceiver used for transmitting a signal on the frequency domain resource unit comprises any one of the following:
determining, based on first configuration information of the frequency domain resource unit sent by the network side device, the transceiver used for transmitting the signal on the frequency domain resource unit, wherein the first configuration information is used to configure a transceiver type used by the frequency domain resource unit; and
determining, based on the second configuration information of the frequency domain resource unit sent by the network side device, the transceiver used for transmitting the signal on the frequency domain resource unit, wherein the second configuration information comprises at least one of the following: a subcarrier spacing, a cyclic prefix, a modulation and coding scheme table, a maximum number of receive antennas, a maximum number of transmit antennas, a maximum number of layers, a maximum rank, a fast Fourier transform length, an inverse fast Fourier transform length, a waveform, or a channel structure.

5. The method according to claim 3, wherein when one frequency domain resource unit is associated with one available transceiver, the method further comprises:
performing a second operation in the preset scenario and when a first target object does not support the default transceiver, wherein
the first target object is a currently activated frequency domain resource unit, and the second operation comprises any one of the following:
keeping the first target object in an active state, stopping transmission behavior on the first target object, and transmitting the preset signal via the default transceiver; and
deactivating the first target object, activating a second target object, and transmitting the preset signal on the second target object via the default transceiver, wherein the second target object is the frequency domain resource unit that supports the default transceiver.

6. The method according to claim 3, wherein when one frequency domain resource unit is associated with at least two available transceivers, the method further comprises at least one of the following:
determining, by the terminal based on indication information sent by the network side device, a transceiver used within a preset time period; or
activating or deactivating, by the terminal based on a first timer, a transceiver associated with the first target object, wherein the first target object is a currently activated frequency domain resource unit.

7. The method according to claim 6, wherein the activating or deactivating, by the terminal based on a first timer, a transceiver associated with the first target object comprises:
when the currently activated transceiver is a first transceiver, deactivating the first transceiver and activating the second transceiver based on the first timer, wherein the transceiver associated with the first target object comprises the first transceiver and the second transceiver, and the second transceiver is a default transceiver of the first target object.

8. The method according to claim 3, wherein when the currently activated transceiver is the second transceiver, the method further comprises: based on a second timer, deactivating a third target object and activating a default frequency domain resource unit, wherein
the second transceiver is a default transceiver of the third target object, the third target object is the currently activated frequency domain resource unit, and the third target object is a non-default frequency domain resource unit.

9. The method according to claim 2, wherein the frequency domain resource unit comprises a carrier or a bandwidth part BWP.

10. The method according to claim 2, wherein when the target information comprises the configuration information of the first signal, the determining, based on target information sent by a network side device, the transceiver used comprises at least one of the following:
determining, based on the configuration information of the first signal sent by the network side device, a transceiver used for the first signal; or
determining, based on the configuration information of the first signal sent by the network side device, a transceiver used for a second signal, wherein the second signal is associated with the first signal.

11. The method according to claim 10, wherein the determining, based on the configuration information of the first signal sent by the network side device, a transceiver used for the first signal comprises:
determining, based on third configuration information of the first signal sent by the network side device, the transceiver used for the first signal, wherein the third configuration information is used to configure a transceiver type used by the first signal; and
determining, based on fourth configuration information of the first signal sent by the network side device, the transceiver used for the first signal, wherein the fourth configuration information comprises at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, or a signal type.

12. The method according to claim 10, wherein the determining, based on the configuration information of the first signal sent by the network side device, a transceiver used for the first signal comprises:
determining, based on the configuration information of the first signal sent by the network side device, transceivers used for different configuration information of the first signal.

13. The method according to claim 2, wherein when the target information comprises the transmission mode-related information, the determining, based on target information sent by a network side device, the transceiver used comprises at least one of the following:
determining a transceiver for a target transmission mode based on the transmission mode-related information, sent by the network side device, of the target transmission mode, wherein
the transmission mode-related information comprises a transmission mode parameter or target indication information, and the target indication information is used to semi-persistently or dynamically indicate the target transmission mode.

14. The method according to claim 13, wherein the transmission mode parameter comprises at least one of the following: a subcarrier spacing, a cyclic prefix, a modulation and coding scheme table, a maximum quantity of receive antennas, a maximum quantity of transmit antennas, a maximum quantity of layers, a maximum rank, a fast Fourier transform length, an inverse fast Fourier transform length, a waveform, a channel structure, or a transceiver type.

15. The method according to claim 1, wherein different types of transceivers correspond to different indicator requirements, and the indicator requirements comprise at least one of the following:
a time domain synchronization requirement;
a time domain calibration error requirement;
a frequency error requirement;
a modulation quality requirement;
a fast Fourier transform length requirement; or
an inverse fast Fourier transform length requirement.

16. A transmission processing method, comprising:
sending, by a network side device, target information to a terminal, wherein the target information is used to determine a transceiver used by the terminal.

17. The method according to claim 16, wherein the target information comprises any one of the following:
configuration information of a frequency domain resource unit;
configuration information of a first signal; and
transmission mode-related information.

18. The method according to claim 17, wherein the frequency domain resource unit comprises a carrier or a bandwidth part BWP.

19. A terminal, comprising a processor and a memory, wherein the memory stores a program or instructions executable on the processor, and when the program or the instructions are executed by the processor, a transmission processing method is implemented, the transmission processing method comprising:
performing a first operation, wherein the first operation comprises at least one of the following:
determining that a transceiver used in a preset scenario is a default transceiver; or
determining, based on target information sent by a network side device, the transceiver used, wherein
the preset scenario comprises at least one of the following:
a preset signal is transmitted;
transmission is on a preset resource; or
the terminal is in a preset state.

20. A network side device, comprising a processor and a memory, wherein the memory stores a program or instructions executable on the processor, and when the program or the instructions are executed by the processor, steps of the transmission processing method according to claim 16 are implemented.
